(19) United States
(12) Patent Application Publication
(10) Pub. No.: US 2019/0381355 A1
(43) Pub. Date: Dec. 19, 2019

(54) SPORT RANGE SIMULATOR

(71) Applicant: aboutGOLF Global, Inc., Kirkland, WA (US)

(72) Inventors: Jeff Cooper, Brighton, MI (US); Randall Henry, Coeur d'Alene, ID (US); Derek Smith, Ann Arbor, MI (US); Kristy Smith, Ann Arbor, MI (US)

(73) Assignee: aboutGOLF Global, Inc., Kirkland, WA (US)

(21) Appl. No.: 16/442,401

(22) Filed: Jun. 14, 2019

Related U.S. Application Data
(60) Provisional application No. 62/686,367, filed on Jun. 18, 2018.
(60) Provisional application No. 62/791,751, filed on Jan. 12, 2019.

(51) Int. Cl. A63B 24/00; G06T 15/20; G06T 19/00; A63B 71/06

(52) U.S. Cl. CPC A63B 24/0021; G06T 15/20; G06T 19/00; G06F 3/0482; G06T 2210/21; G06T 2200/24; A63B 71/0622

(57) ABSTRACT

Various implementations of a “Shared Location-Dependent Perspective Renderer” render background scenes onto shared display devices that are virtually segmented into two or more virtual viewports. Each virtual viewport corresponds to a separate physical region positioned relative the shared display. Each viewport is further defined by different virtual camera FOVs and vanishing points relative to the shared display. Physical objects launched towards the shared display from any physical region are rendered into the corresponding viewport as visible virtual objects based on both physical object trajectories and the corresponding vanishing point. Target objects rendered into the background scene from the perspective of any virtual viewport are also separately positioned into one or more of the other viewports as invisible virtual objects based, in part, on the vanishing points associated with those other virtual viewports. Visible and invisible virtual objects are tracked to detect virtual collisions within any of the virtual viewports.

### CROSS-REFERENCE TO RELATED APPLICATIONS

This application claims the benefit under Title 35, U.S. Code, Section 119(e), of a previously filed U.S. Provisional Patent Application Ser. No. 62/686,367 filed on Jun. 18, 2018, by Jeff Cooper, et al., and entitled “INDOOR SPORT RANGE SIMULATOR”. In addition, this application also claims the benefit under Title 35, U.S. Code, Section 119(e), of a previously filed U.S. Provisional Patent Application Ser. No. 62/791,751 filed on Jan. 12, 2019, by Jeff Cooper, et al., and entitled “INDOOR SPORT RANGE SIMULATOR”.

### BACKGROUND

Simulated sport ranges often include one or more fully or partially enclosed spaces having one or more displays or projections for rendering virtual environments associated with a particular sport being simulated. In addition to such displays or projections, simulated sport ranges often include one or more physical objects (e.g., golf club and balls, baseball bat and balls, etc.) and various tracking modalities for tracking user and physical object motions and interactions with the virtual environment. Typically, these simulated sport ranges operate as individual virtual environments. In some cases, interaction between two or more of these simulated sport ranges enables a pseudo-cooperative virtual environment wherein users in individual enclosed spaces take turns interacting with a separate version of the virtual environment associated with their particular simulated sport range. Such pseudo-cooperative interactions may include, for example, information or videos relating to scores or actions of individual users and presenting such information or videos to other users within their own virtual environment on a turn-by-turn basis.

### SUMMARY

The following Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of other technologies may be discussed herein, the claimed subject matter is not intended to be limited to implementations that may solve or address any or all of the disadvantages of those other technologies. The sole purpose of this Summary is to present some concepts of the claimed subject matter in a simplified form as a prelude to the more detailed description that is presented below.

In general, a “Shared Location-Dependent Perspective Renderer,” as described herein, provides various computer-based techniques for rendering an interactive virtual environment. For example, in one implementation, the Shared Location-Dependent Perspective Renderer begins operation by applying one or more computing devices to display a background scene on a shared display device. In addition, the Shared Location-Dependent Perspective Renderer delineates or otherwise defines a field of view (FOV) and a corresponding vanishing point for each of a plurality of physical regions positioned relative to the shared display device. Then, relative to the vanishing point of one of the FOV's, the Shared Location-Dependent Perspective Renderer renders a collidable visible virtual target object into the background scene. Further, relative to the vanishing points of one or more of the other FOV's, the Shared Location-Dependent Perspective Renderer positions an invisible version of the virtual target object into the background scene. In addition, for one or more of the physical regions, the Shared Location-Dependent Perspective Renderer determines an actual trajectory of a physical object launched from the corresponding physical region towards the shared display device. Finally, responsive to the actual trajectory and further responsive to the corresponding vanishing point, the Shared Location-Dependent Perspective Renderer renders a visible dynamic virtual representation of the physical object into the background scene within the FOV of the physical region from which the physical object was launched. In various implementations, within any FOV, the Shared Location-Dependent Perspective Renderer optionally detects virtual collisions between any of the visible virtual target objects or the invisible version of the virtual target object and any corresponding visible dynamic virtual representation of the physical object.

Similarly, in another implementation, the Shared Location-Dependent Perspective Renderer is instantiated as a system that includes a hardware processor device, a shared display device, and a memory device that stores machine-readable instructions which, when executed by the hardware processor device, cause the hardware processor device to render a virtual environment on a shared display device. In addition, for each of a plurality of physical bays positioned relative to the shared display device, the Shared Location-Dependent Perspective Renderer delineates or otherwise defines a corresponding field of view (FOV) covering at least a portion of the shared display device and further delineates a corresponding vanishing point for each FOV. Further, for one of the bays, responsive to the corresponding FOV and vanishing point, the Shared Location-Dependent Perspective Renderer renders a visible virtual target object into the virtual environment. Then, for each of one or more of the other bays, responsive to the FOV and vanishing point of each of those other bays, the Shared Location-Dependent Perspective Renderer positions a separate instance of an invisible virtual object corresponding to the visible virtual target object into the virtual environment. In addition, for each of one or more of the bays, the Shared Location-Dependent Perspective Renderer determines an actual trajectory of a physical object launched from the corresponding bay towards the shared display device. Finally, responsive to the physical objects launched from one or more of the bays, the Shared Location-Dependent Perspective Renderer renders a corresponding visible virtual object into the virtual environment, each visible virtual object having a virtual trajectory determined from the corresponding actual trajectory, the FOV and the vanishing point of the corresponding bay.

Similarly, in another implementation, the Shared Location-Dependent Perspective Renderer is instantiated as a system that includes a hardware processor device, a shared display device and a memory device that stores machine-readable instructions which, when executed by the hardware processor device, cause the hardware processor device to render a virtual environment on the shared display device. In addition, for each of two or more separate physical locations positioned relative to the shared display device, the Shared Location-Dependent Perspective Renderer determines a corresponding vanishing point of a field of view (FOV) of a virtual camera positioned within each of the physical locations. Further, for one or more of the physical locations, the Shared Location-Dependent Perspective Renderer determines an actual trajectory of a physical object launched from the corresponding physical location towards the shared display device. Finally, responsive to each actual trajectory and further responsive to the FOV and vanishing point associated with the corresponding physical location, the Shared Location-Dependent Perspective Renderer renders a perspective correct visible virtual object representative of the physical object onto the virtual environment, each visible virtual object having a virtual trajectory determined from the corresponding actual trajectory, the FOV and the vanishing point of the corresponding physical location.

The Shared Location-Dependent Perspective Renderer described herein provides various techniques for rendering a large virtual environment on a shared display device having multiple location-dependent perspective FOV's or viewports that enable users in separate physical regions positioned relative to the shared display device to virtually interact with either or both the large virtual environment and with virtual target objects via virtual representations of physical objects (also including lasers and optical beams) launched towards the shared display device from one or more of the separate physical regions. In addition to the benefits described above, other advantages of the Shared Location-Dependent Perspective Renderer will become apparent from the detailed description that follows hereinafter.

### BRIEF DESCRIPTION OF THE DRAWINGS

The specific features, aspects, and advantages of the claimed subject matter will become better understood with regard to the following description, appended claims, and accompanying drawings where:

FIG. 1 provides an exemplary architectural flow diagram that illustrates subprograms for effecting various implementations of a “Shared Location-Dependent Perspective Renderer,” as described herein.

FIG. 2 illustrates exemplary physical regions (“bays”) positioned in front of a shared display and showing corresponding optionally overlapping virtual viewports, as described herein.

FIG. 3 illustrates exemplary determination of the position of an invisible virtual object, O′, in the viewport of one bay relative to a corresponding visible virtual object, O, in the viewport of another bay, e.g., translating of a visible virtual object in one viewport to a corresponding invisible virtual object in another viewport, as described herein.

FIG. 4 provides a general system flow diagram that illustrates the exemplary determination of the position of an invisible object in accordance with FIG. 3, as described herein.

FIG. 5 illustrates a general system flow diagram that illustrates exemplary techniques for effecting various implementations of the Shared Location-Dependent Perspective Renderer, as described herein.

FIG. 6 illustrates a general system flow diagram that illustrates exemplary techniques for effecting various implementations of the Shared Location-Dependent Perspective Renderer, as described herein.

FIG. 7 illustrates a general system flow diagram that illustrates exemplary techniques for effecting various implementations of the Shared Location-Dependent Perspective Renderer, as described herein.

FIG. 8 illustrates a general system diagram that depicts a variety of alternative computing systems and communications interfaces for use in effecting various implementations of the Shared Location-Dependent Perspective Renderer, as described herein.

FIG. 9 is a general system diagram depicting a simplified general-purpose computing device having simplified computing and I/O capabilities for use in effecting various implementations of the Shared Location-Dependent Perspective Renderer, as described herein.

### DETAILED DESCRIPTION

In the following description of various implementations of a “Shared Location-Dependent Perspective Renderer,” reference is made to the accompanying drawings, which form a part hereof, and in which is shown by way of illustration specific implementations in which the Shared Location-Dependent Perspective Renderer may be practiced. Other implementations may be utilized and structural changes may be made without departing from the scope thereof. For purposes of brevity, the Shared Location-Dependent Perspective Renderer will also be referred to herein simply as the “Shared Perspective Renderer.”

Specific terminology will be resorted to in describing the various implementations described herein, and it is not intended for these implementations to be limited to the specific terms so chosen. Furthermore, each specific term includes all its technical equivalents that operate in a broadly similar manner to achieve a similar purpose. Reference herein to “one implementation,” or “another implementation,” or an “exemplary implementation,” or an “alternate implementation” or similar phrases, means that a particular feature, a particular structure, or particular characteristics described in connection with the implementation can be included in at least one implementation of the Shared Location-Dependent Perspective Renderer. Further, the appearance of such phrases throughout the specification are not necessarily all referring to the same implementation, and separate or alternative implementations are not mutually exclusive of other implementations. The order described or illustrated herein for any process flows representing one or more implementations of the Shared Location-Dependent Perspective Renderer does not inherently indicate any requirement for the processes to be implemented in the order described or illustrated, and any such order described or illustrated herein for any process flows do not imply any limitations of the Shared Location-Dependent Perspective Renderer.

As utilized herein, the terms “component,” “system,” “client” and the like are intended to refer to a computer-related entity, either hardware, software (e.g., in execution), firmware, or a combination thereof. For example, a component can be a process running on a processor, an object, an executable, a program, a function, a library, a subroutine, a computer, or a combination of software and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive in a manner similar to the term “comprising” as an open transition word without precluding any additional or other elements.

1.0 Introduction:

In general, a “Shared Location-Dependent Perspective Renderer” provides various techniques for rendering a large virtual environment (e.g., a background scene including any combination of 2D images, photos or videos, or 3D scenes such as a golf course, football field, bowling alley, soccer field, indoor or outdoor scene, outer space, etc.) on a shared display device. A “shared display device” means a device having one or more projectors which project one or more images, such as a golf course, onto a surface capable of displaying a computer rendered scene, including, but not limited to, a LED display, wall, screen, net, volumetric projection, etc. In various implementations, having multiple location-dependent perspective fields of view enables users in separate physical regions positioned relative to the shared display device to virtually interact with either or both the large virtual environment and with collidable virtual target objects via virtual representations of physical objects launched towards the shared display device from one or more of the separate physical regions.

In various implementations, if an object (e.g., a virtual target object) is collidable, then that object is visible within one field of view (FOV) or virtual viewport (or within the overall virtual environment relative to a particular virtual viewport or FOV) and invisibly positioned in one or more of the other virtual viewports or FOV's relative to the corresponding vanishing points of the viewports or FOV's. In addition, physical balls or other objects (including any physical objects and/or lasers or optical beams) launched from a bay towards the shared display device are rendered as visible virtual objects in the corresponding viewport or FOV based on the corresponding vanishing points. In various implementations, any of these physical balls or other objects are optionally positioned (again based on the corresponding vanishing points) as invisible virtual objects in one or more of the other virtual viewports if those invisible virtual objects are intended to be collidable with other visible virtual objects.

In various implementations, the background scene may have either or both static and dynamic components (e.g., moving or fixed static and/or dynamic virtual objects such as dart boards, aircraft, blimps, balloons, ground vehicles, animals, people, etc.). As used herein “background scene” means anything in the full screen viewport or FOV not specific to the user's bay. As a simple non-limiting example, consider dynamic drifting balloons and wind-blown trees on an otherwise static golf course scene. Any of these static and dynamic components may by treated by the Shared Location-Dependent Perspective Renderer as visible virtual objects and may also be treated as collidable visible virtual target objects, as described herein. Further, any number of visible virtual objects and/or collidable visible virtual target objects may be included in the large virtual environment and/or in any of the virtual viewports or FOV's. In various implementations, the background scene is associated with a single field of view (e.g., a “background viewport”) that covers the entire shared display device and a vanishing point based on a corresponding virtual camera positioned relative to the shared display device.

In various implementations, the large virtual environment (e.g., the background scene displayed within a “background viewport” covering the shared display device) is virtually segmented into multiple location-dependent FOV's or perspective viewports (also referred to herein as “virtual viewports”). This segmentation corresponds to separate physical regions (also referred to herein as a “bay”). More specifically, each virtual viewport or FOV corresponds to a separate bay positioned relative to the front of the shared display device. Each viewport is further defined by a different virtual camera FOV relative to a virtual camera or the like defined for each corresponding bay and corresponding vanishing points within each FOV relative to the shared display. In various implementations, the viewports of any two or more adjacent bays (i.e., adjacent fields of view) are at least partially overlapping relative to the large virtual environment. In other words, each of the virtual viewports represents a separate FOV covering a segment of the large virtual environment based on the real-world location of the corresponding bay relative to the shared display device.

The use of multiple virtual viewports or FOVs enables users in separate bays positioned relative to the shared display device to virtually interact with either or both the large virtual environment and with virtual representations of physical objects launched towards the shared display device from one or more of the separate bays. Examples of launching a physical object include, but are not limited to, physical objects that are thrown by hand or via a physical device or tool, hit by hand or via a physical device or tool, rolled, kicked, pushed, shot, etc. Examples of such physical objects include, but are not limited to, golf balls, baseballs, footballs, soccer balls, hockey pucks, bowling balls, marbles, snowballs, rocks, flying discs, stuffed animal toys, paintballs, arrows, missiles, bullets, or any other physical object (also including lasers and optical beams) that can be launched from any physical region towards the shared display device.

Physical objects launched towards the shared display from any bay are rendered into the corresponding viewport or FOV as visible virtual objects having virtual trajectories based on both physical object trajectories and the corresponding vanishing point. As such, visible virtual objects rendered as dynamic projections into one of the virtual viewports are visible within the large virtual environment based on the perspective or vanishing point associated with that viewport. Further, because these visible virtual objects are visible within the large virtual environment, these visible virtual objects are also visible to users in some or all of the other bays. Similarly, static or dynamic instances of any virtual object (whether or not that object is associated an actual physical object) may also be rendered into any of the virtual viewports as visible virtual objects. In various implementations, if a visible object is intended to be collidable, instances of any of the visible virtual objects are separately positioned into one or more of the other virtual viewports as invisible virtual objects based, in part, on the vanishing points associated with those other viewports. In various implementations, visible and invisible virtual objects are tracked to detect virtual collisions between any visible and/or invisible virtual objects within any of the virtual viewports or FOVs. In other words, any two or more different visible and/or invisible virtual objects may be “collidable” in the sense that virtual collisions can be detected in the graphics space of a rendering engine used by the Shared Perspective Renderer to generate the images being presented on the shared display device.

For example, in various implementations, visible virtual objects (whether or not they are associated with actual physical objects) are rendered as a dynamic projection or overlay on a section of the large virtual environment associated with corresponding FOV's or virtual viewports. In the case of correspondence to physical objects launched towards the shared display device, this dynamic projection or overlay is at least partially based on a computed trajectory of the corresponding physical object and a perspective or vanishing point associated with the corresponding viewport.

In various implementations, a computed trajectory of each invisible virtual object differs from the trajectory of the corresponding visible virtual objects to account for perspective differences (e.g., different virtual vanishing points) between each of the different FOV's or virtual viewports. In other words, the trajectory of any particular invisible object will be different for each of the location-dependent perspective viewports into which that invisible object is positioned based on the virtual vanishing point and physical location associated with each corresponding FOV or virtual viewport. As such, these computed trajectories enable virtual collision detections between an invisible object in any of virtual viewports and a different visible virtual object in that same virtual viewport.

Advantageously, the use of individual virtual viewports on a per-bay basis enables the Shared Perspective Renderer to render visible virtual objects onto the shared display device relative to the FOV or viewport associated with any particular bay. This capability enables the Shared Perspective Renderer to maintain realistic perspective correct views from any bay of visible virtual objects rendered onto the virtual environment relative to any corresponding FOV or virtual viewport. As a further advantage, the use of the overall virtual environment in combination with the per-bay perspective or vanishing point for rendering of visible objects increases a visual realism of the overall scene (e.g., the combination of the background scene and visible virtual objects) for users positioned in each of the separate bays. In various implementations, and depending on bay size, any number of users may occupy a particular bay. An additional advantage is that the Shared Location-Dependent Perspective Renderer improves user interactions by providing users with a shared experience that enables users in any of the separate bays to virtually interact with either or both purely virtual objects rendered onto the background scene and/or virtual representations of actual physical objects (also rendered onto the background scene) that are physically launched towards the shared display device from one or more of the separate bays.

1.1 System Overview:

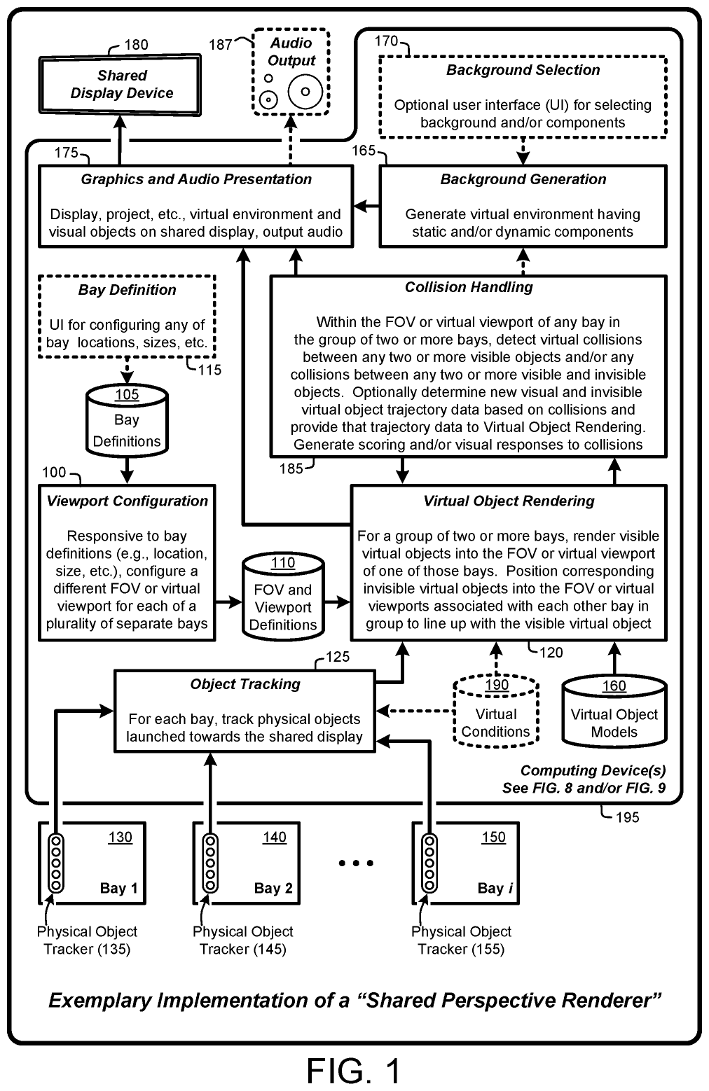

As mentioned, the Shared Location-Dependent Perspective Renderer provides various techniques for rendering a large virtual environment on a shared display device having multiple location-dependent perspective viewports that enable users in separate physical regions (e.g., “bays”) positioned relative to the shared display device to virtually interact with either or both the large virtual environment and with virtual representations of physical objects launched towards the shared display device from one or more of the separate physical regions. The processes summarized above are illustrated by the general system diagram of FIG. 1. In particular, the system diagram of FIG. 1 illustrates the interrelationships between programs and subprograms for implementing various implementations of the Shared Perspective Renderer, as described herein. Furthermore, while the system diagram of FIG. 1 illustrates a high-level view of various implementations of the Shared Perspective Renderer, FIG. 1 is not intended to provide an exhaustive or complete illustration of every possible implementation of the Shared Perspective Renderer as described throughout this document.

In addition, any boxes and interconnections between boxes that may be represented by broken or dashed lines in FIG. 1 represent alternate implementations of the Shared Perspective Renderer described herein, and any or all of these alternate implementations, as described below, may be used in combination with other alternate implementations that are described throughout this document.

As illustrated by FIG. 1, in various implementations, the processes enabled by the Shared Perspective Renderer begin operation by applying one or more computing devices 195 to execute a viewport configuration subprogram 100 (and each of the other subprograms described herein) to configure a different FOV or virtual viewport for each of a plurality of separate bays (e.g., bays 130, 140, 150) based on various bay definitions (105), e.g., bay location, size, etc. In other words, the viewport configuration subprogram 100 generates a set of FOVs or virtual viewport definitions 110 for the plurality of bays (e.g., bays 130, 140, 150) based on the set of bay definitions 105. In general, generating the set of FOV's or virtual viewport definitions 110 is based on factors including, but not limited to physical locations or positions of bays (e.g., bays 130, 140, 150) relative to a shared display device 180, physical sizes of bays, position, FOV and vanishing point of a virtual camera position in each bay, etc.

When grouping bays (e.g., bays 130, 140, 150) for purposes of cooperative or competitive user interactions, two or more bays are virtually grouped. It is not required that grouped bays (e.g., bays 130, 140, 150) are adjacent. However, depending upon factors such as, for example, separation of the bays (e.g., bays 130, 140, 150), distance of the bays from the front of the shared display device 180, size of the shared display device, etc., the use of adjacent bays for forming groups may provide improved visual characteristics (e.g., a shared virtual target object) and improved user interaction with respect to user view of the shared display device and of the FOV's or virtual viewports of other bays in the group.

Given the FOV's or virtual viewport definitions 110, the Shared Perspective Renderer applies a virtual object rendering subprogram 120 for a group of two or more bays (e.g., bays 130, 140, 150), or a single bay group, to render one or more visible virtual objects into the FOV or virtual viewport of one or more of the bays in the group. In general, the virtual object rendering subprogram 120 positions corresponding invisible virtual objects into the FOV or virtual viewports associated with each other bay in the group to line up with the corresponding visible virtual objects. As discussed herein, such positioning is performed via various transformations (e.g., scale, translate, rotate, etc.) to position the invisible virtual object within one the FOV or virtual viewport of one of the bays such that the invisible virtual object lines up with the corresponding visible virtual object in another of the bays based on each bays FOV or virtual viewport. In the case of a single bay group (e.g., bay 130, 140, or 150), the Shared Perspective Renderer renders the visible virtual object into the virtual viewport of that single bay. In various implementations, a set of predefined virtual object models 160 (e.g., images, 2D and/or 3D models of objects such as, for example, golf balls, baseballs, footballs, soccer balls, hockey pucks, bowling balls, marbles, snowballs, rocks, flying discs, stuffed animal toys, paintballs, arrows, missiles, bullets, or any other physical object) is used by the virtual object rendering subprogram 120 for rendering purposes.

In various implementations, each of a plurality of visible virtual objects, and optionally, corresponding invisible virtual objects, correspond to one or more physical objects launched towards the shared display device 180 from any bay (e.g., bays 130, 140, 150). Physical tracking of launched physical objects is provided by an object tracking subprogram 125 based on conventional physical object trackers or sensors (135, 145, 155) associated with each of the bays. In general, the object tracking subprogram 125 generates trajectory data (e.g., speed, direction, launch angle, spin, etc.) based on the tracking information provided by the trackers or sensors (135, 145, 155). This tracking data is then applied to generate virtual trajectories for the corresponding visible virtual objects and the optional corresponding invisible virtual objects. For example, in various implementations, once computed, the trajectory data for each physical object is provided to the virtual object rendering subprogram 120 for use in generating the visible virtual objects and optional corresponding invisible virtual objects based on the corresponding virtual trajectories.

In various implementations, the virtual trajectories are optionally modified when generating corresponding visible virtual objects and invisible virtual objects based on virtual conditions 190 (e.g., weather and physical conditions such as, for example, wind speed, humidity, rain, temperature, real or simulated gravity fields, speed, physical characteristics such as size, shape, weight, etc. of the physical objects, and/or physical characteristics of objects used to hit or otherwise launch physical objects, etc.). In various implementations, the virtual conditions 190 are configured, modified and/or selected via a user interface (not shown). In other words, these virtual conditions may be applied to modify virtual trajectories of visible virtual objects corresponding to physical objects launched towards the shared display device 180. In addition, in the case of purely virtual objects (i.e., not associated with physical objects) having motion or trajectories, the virtual conditions 190 can optionally be applied by the virtual object rendering subprogram 120 to modify the motions or virtual trajectories associated with both visible and invisible versions of those purely virtual objects.

The virtual object rendering subprogram 120 provides the rendered visible virtual objects to a graphics and audio presentation subprogram 175. The graphics and audio presentation subprogram 175 then displays, projects, or otherwise presents these rendered visible virtual objects on the shared display device 180 as overlays, projections, sprites, etc., within an overall virtual environment generated by a rendering engine or the like, e.g., a background generation subprogram 165. In general, with respect to the virtual environment, the background subprogram 165 applies conventional rendering techniques that consider various geometries and things such as, for example, terrain, sky, objects, etc., in the background viewport for use in generating a 2D image of a 2D or 3D scene to display on the shared display device 180. In addition, in various implementations, the graphics and audio presentation subprogram 175 optionally sends an audio output stream (e.g., sound effects, music, speech, etc.) to an audio output device 187 to provide an audio accompaniment relating to the virtual environment, visible virtual objects, collision detections, etc. One or more audio output devices 187 (e.g., amplified speaker systems or the like) then provide such sound effects within individual bays and/or in one or more physical locations positioned relative to the bays and/or the shared display device 180.

In general, the background generation subprogram 165 generates a virtual environment (e.g., 2D and/or 3D scenes such as a golf course, football field, bowling alley, soccer field, indoor or outdoor scene, outer space, etc.). In various implementations, this virtual environment has a normal perspective correct projection relative to a virtual camera centered on the middle of the large overall screen (e.g., shared display device 180). The background generation subprogram 165 ensures that virtual objects in the virtual environment look reasonable from the vantage point of each bay. For example, consider a virtual environment representing a golf driving range that has a tree line far in the distance. In this example, if a small square building (shown from a directly frontal perspective) is positioned in the near foreground, of the virtual environment, it would be obvious to a viewers in the different bays that the building looks most correct from a perspective of a bay positioned directly in line with the horizontal (and possibly vertical) center of the shared display device 180. In other words, given the directly frontal perspective of the building rendering, viewers in bays positioned to the right side of the building will not see the right side of the building, and viewers in bays positioned to the left side of the building will not see the left side of the building. As such, in various implementations, both the overall virtual environment within the background viewport and any objects positioned within either the background viewport or within individual virtual viewports or FOV's are chosen to ensure that the virtual environment and virtual objects appear to have an approximately perspective correct appearance from the perspective of some or all of the bays. For example, spherical, cylindrical and very thin objects (e.g., a flat virtual dartboard, or field goal posts which are both cylindrical and thin) will appear to have a perspective correct appearance from each bay.

In addition, the virtual environment generated by the background generation subprogram 165 may include either or both static and dynamic components as described herein. In various implementations, a background selection subprogram 170 is provided via an optional user interface (UI) that enables one or more users to select some or all of the features or components of the virtual environment generated as a background by the background generation subprogram 165. More specifically, in various implementations, the background selection subprogram 170 enables users to select from a plurality of predefined backgrounds or virtual environments, customize any or all of the predefined backgrounds or virtual environments, add or remove virtual components (e.g., collidable virtual target objects, non-collidable virtual objects, etc.) to or from any of the predefined backgrounds or virtual environments from a plurality of user selectable virtual objects. In the case that collidable virtual target objects are added to the background, such objects will be visibly positioned (i.e., treated as a visible virtual object) by the Shared Perspective Renderer relative to either the overall background viewport or to one of the virtual viewports or FOVs, with corresponding invisible versions (i.e., invisible virtual objects) being positioned in one or more of the other virtual viewports or FOVs as discussed. Further, when any virtual target object (e.g., a collidable visible virtual object) is used to enable or allow virtual collisions from multiple bays, this scenario is sometimes referred to herein as a “common target mode.”

In various implementations, a collision handling subprogram 185 operates to detect virtual collisions between any two or more visible virtual objects and/or any collisions between any two or more of visible virtual objects and invisible virtual objects in any of the viewports. In addition, in various implementations, the collision handling subprogram 185 optionally determines new visual and/or invisible virtual object trajectory data based on collisions and provides that new trajectory data to the virtual object rendering subprogram 120 for use in rendering or positioning any corresponding visible and/or invisible virtual objects, as described. For example, a collision between a virtual ball and a virtual golf cart may cause the virtual ball to change direction responsive to that virtual collision. In further implementations, the collision handling subprogram 185 generates scoring data, and/or any desired combination of audio and/or visual responses (e.g., score updates, sounds, explosions, virtual environment changes, etc.) in response to collision detections (and/or to collision misses where a collision attempted by a user fails to occur). Any such scoring updates, audio, or visual responses or updates can be provided to any or all of the background generation subprogram 165 (for virtual environment changes or updates) and the graphics and audio presentation subprogram 175 for presentation of other visual and audio effects.

2.0 Exemplary Operational Details:

The above-described subprograms and/or devices are employed for instantiating various implementations of the Shared Perspective Renderer. As summarized above, the Shared Perspective Renderer provides various techniques for rendering a large virtual environment on a shared display device having multiple location-dependent perspective viewports that enable users in separate physical regions positioned relative to the shared display device to virtually interact with either or both the large virtual environment and with virtual representations of physical objects launched towards the shared display device from one or more of the separate physical regions. The following sections provide a detailed discussion of the operation of various implementations of the Shared Perspective Renderer, and of exemplary methods and techniques for implementing the features and subprograms described in Section 1 with respect to FIG. 1. In particular, the following sections provide examples and operational details of various implementations of the Shared Perspective Renderer, including:

Operational Overview of the Shared Perspective Renderer;

Per-Bay Perspective Correct Field of View;

Grouping Bays;

Perspective Correct Display of Background Virtual Environment;

Per-Bay Physical Object Tracking;

Positioning the Same Virtual Object in Multiple Viewports;

Collision Detections and Handling; and

Considerations for Local and Remote Computing Resources.

2.1 Operational Overview of the Shared Perspective Renderer:

As mentioned above, the Shared Location-Dependent Perspective Renderer provides various techniques for rendering a large virtual environment on a shared display device having multiple location-dependent perspective viewports or FOV's that enable users in separate physical regions positioned relative to the shared display device to virtually interact with either or both the large virtual environment and with virtual representations of physical objects launched towards the shared display device from one or more of the separate physical regions (e.g., separate physical bays).

2.2 Per-Bay Perspective Correct Field of View:

In general, multiple physical bays are physically positioned relative to a front of the shared display device such that some or all of the surface of the shared display device is visible from each of the bays. Delineation of the positions and sizes of individual bays may be fixed or variable. For example, assume for purposes of discussion that one or more of the bays is defined by a room or other demarcated region having full or partial height walls, barriers, separation markers on the floor, etc., fully or partially extending along left and right sides of the bay with an open front side (e.g., low walls, no walls, limited or no obstructions, etc.) facing the shared display device. A rear side of each bay may be fully or partially open or closed, as desired. Further, bays can be positioned in any desired physical layouts and spacing relative to the shared display device. For example, bays may be arranged in a linear or curved pattern in a single row, a linear or curved pattern in multiple vertically stacked rows (e.g., one or more vertically stacked rows of bays on different levels or floors of a building or other structure). Further, any bays may be of different sizes whether they are in the same or different rows. For example, bays on a first level may be smaller than bays on an upper level when rows of bays are vertically stacked. Further, different rows may include different numbers of bays than other rows.

Typically, the shared display device is physically larger (at least in width) than the collection of bays arranged in front of the shared display device. As such, since no two bays occupy the same physical region, a user's view of the shared display device from within a particular bay will have a different real-world perspective from that of users in any other bay. As such, the perspective or vanishing point associated with a FOV (e.g., of a virtual camera) from each bay differs from each other bay based on the positions of those bays relative to the shared display device. In other words, every bay has a different perspective view of the virtual environment being presented on the shared display device.

In various implementations, these bay-specific perspective views are delineated by optionally overlapping virtual viewports or FOV's associated with each bay. In another implementation, these different perspectives are based on the use of a single-viewport display (e.g., covering the entire shared display device) in combination with transforming virtual objects (e.g., scale, translate, rotate, etc.) displayed in the single viewport so that they appear to have a correct perspective for a given bay. In another implementation, these different perspectives are based on the use of a 3D background scene (or a 2D image, photo, or video) in combination with transformations of bay-specific real or virtual objects to 2D images overlaid in screen space. In any or all of these implementations, the field of view corresponding to separate bays may be fully or partially overlapping (horizontally and/or vertically) to any desired degree such that the FOV of each bay covers some or all of the background viewport covering the overall shared display device.

In general, there are many different mathematical techniques that can be adapted to provide multiple location-dependent (e.g., bays) perspective correctness relative to the virtual environment being rendered on the shared display. As such, the Shared Perspective Renderer is not intended to be limited to the case where the virtual environment is divided or otherwise virtually segmented into separate virtual viewports. Various examples of such techniques are summarized in Sections 2.2.1, 2.2.2 and 2.2.3 of this document. The examples provided in Sections 2.2.1, 2.2.2 and 2.2.3 are provided for purpose of explanation and discussion and are not intended to provide an exhaustive list of all techniques for providing multiple location-dependent (e.g., bays) perspective correctness relative to the virtual environment being rendered on the shared display. However, for purpose of explanation and discussion, this document will generally refer to implementations involving the use of virtual viewports, with the understanding that any desired technique for providing bay-specific perspective correct views of visible virtual objects and visible virtual target objects is applicable to any of the implementations described herein.

2.2.1 Per-Bay Virtual Viewports:

In various implementations, the Shared Perspective Renderer divides or otherwise virtually segments the shared display into a virtual viewport for each bay. Individual virtual viewports are not restricted in size, and may be larger, smaller, or the same size as the shared display device. In various implementations, the virtual viewports of any two or more adjacent bays (i.e., adjacent fields of view) may be fully or partially overlapping relative to the large virtual environment. However, there is no requirement for such overlapping.

As mentioned, each virtual viewport represents a field of view (and a virtual vanishing point) of a virtual camera positioned within the corresponding bay. As such, the FOV and vanishing point (and thus the perspective) associated with each bay differs from each other bay based on the positions of those bays relative to the shared display device. Advantageously, the use of individual virtual viewports and FOV's on a per-bay basis enables the Shared Perspective Renderer to render visible virtual objects onto the shared display device relative to the viewport associated with any particular bay. This capability enables the Shared Perspective Renderer to maintain realistic perspective correct views, from any bay, of visible virtual objects (also including visible virtual target objects) rendered onto or into the virtual environment relative to any corresponding virtual viewport. Such implementations provide multiple location-dependent (e.g., bays) perspective correctness relative to the shared display, thereby enabling simultaneous interaction with the background scene (and with various visible and invisible virtual objects) among any or all of the locations or bays.

In other words, in various implementations, the large virtual environment being rendered on the shared display device is virtually segmented into multiple location-dependent perspective viewports on a per-bay basis. This segmentation corresponds to separate physical regions defining each bay. Each virtual viewport can be delineated by a different virtual camera FOV defined for each corresponding bay. In addition, each virtual viewport includes a corresponding bay-dependent vanishing point relative to the virtual environment being rendered on the shared display device. The bay-dependent vanishing points for each virtual viewport differ from a vanishing point associated with the overall virtual environment (e.g., within the overall background viewport) being rendered on the shared display device. However, a virtual vanishing point associated with the virtual viewport of any particular bay that is approximately centered (e.g., horizontally and/or vertically) relative to the shared display device may have approximately the same vanishing point as the overall virtual environment being rendered within the background viewport on the shared display device. In other words, in various implementations, there is a FOV and vanishing point associated with the overall virtual environment being rendered within the background viewport on the shared display device, and separate FOV's and vanishing points associated with each of the bays.

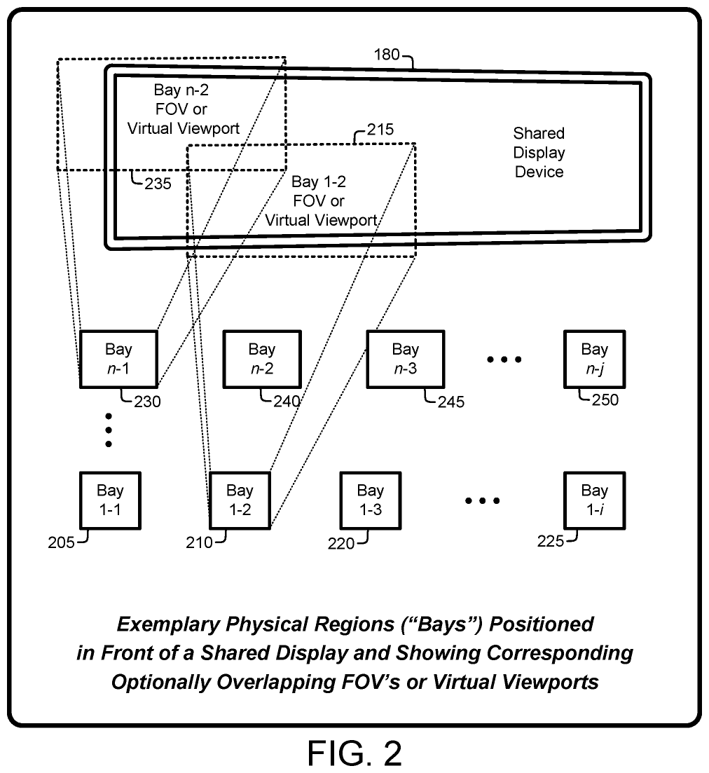

The schematic diagram of FIG. 2 illustrates exemplary physical regions (“bays”) positioned in front of a shared display and showing corresponding optionally overlapping FOV's or virtual viewports, as described herein. However, the schematic diagram of FIG. 2 is provided only for purposes of illustrating the use of per-bay FOV's or virtual viewports and is not intended to limit the Shared Perspective Renderer with respect to the sizes, positions or numbers of bays, and is not intended to limit the Shared Perspective Renderer with respect to sizes, positions or overlaps of FOV's or virtual viewports or FOV's corresponding to the individual bays.

As illustrated by FIG. 2, in various implementations, one or more rows of bays (e.g., 205, 210, 220, 225, 230, 240, 245, 250) are arranged on separate levels positioned towards a front side of the shared display device 180. In the example of FIG. 2, it is intended that bays 205, 210, 220 and 225 are on a first level (e.g., a first floor of a building) while bays 230, 240, 245, 250 are on a second level (e.g., a second floor) of that building. Each of these bays (e.g., 205, 210, 220, 225, 230, 240, 245, 250) has a view of some or all of the shared display device 180, and thus a view of the virtual environment being rendered on that display device. Individual FOV's or viewports covering some or all of the shared display device 180 are defined for each bay (e.g., 205, 210, 220, 225, 230, 240, 245, 250) based on the FOV of a virtual camera (not shown) positioned within each bay. FIG. 2 illustrates partially overlapping FOV's or virtual viewports (215 and 235, respectively) for bay 210 (on the first level) and bay 230 (on the second level).

2.2.2 Global Viewport with Per-Bay Virtual Object Transforms:

In various implementations, rather than dividing or otherwise virtually segmenting the shared display into a separate virtual viewport for each bay, the Shared Perspective Renderer instead treats the entire shared display as a single global viewport (e.g., covering the entire background viewport). In such implementations, the Shared Perspective Renderer still considers the FOV and vanishing point of a virtual camera positioned within each corresponding bay. However, in contrast to using these FOVs for viewport segmentation, the Shared Perspective Renderer uses the per-bay FOVs and vanishing points to perform various transforms (e.g., various combinations of scaling, translating, and/or rotating) of visible virtual objects, visible virtual target objects and invisible virtual objects within the single global viewport so that all such virtual objects appear to have a correct perspective for the corresponding bay. As such, these transforms also operate to position invisible virtual objects from the perspective of each per-bay FOV so that those invisible virtual objects line up with corresponding visible virtual objects or visible virtual target objects in other bays.

Given these transforms, visible virtual objects or visible virtual target objects and corresponding invisible virtual objects within the FOV of a particular bay will have approximately the same position relative to that bay and to the shared display device as those visible and invisible virtual objects would have had in the case described in Section 2.2.1 of this document with respect to the use of individual virtual viewports for each bay. As with the per-bay virtual viewport implementations, such implementations provide multiple location-dependent (e.g., bays) perspective correctness relative to the shared display device, thereby enabling simultaneous interaction with the background scene (and various visible and invisible virtual objects) among any or all of the locations or bays.

2.2.3 Common Scene with Bay-Specific Virtual Object Overlays:

In various implementations, rather than dividing or otherwise virtually segmenting the shared display into a separate virtual viewport for each bay, the Shared Perspective Renderer instead treats the visible virtual objects, the visible virtual target objects and the invisible virtual objects as overlays on the background scene. In such implementations, the Shared Perspective Renderer still considers the FOV and vanishing point of a virtual camera positioned within each corresponding bay. However, in contrast to using this FOV and vanishing point for viewport segmentation, the Shared Perspective Renderer instead uses the per-bay FOV and vanishing point to perform various transforms of these overlays, whether visible or invisible, via various combinations of scaling, translating, and/or rotating these overlays so that all corresponding visible and invisible virtual objects appear to have a correct perspective for the corresponding bay. As such, these transforms operate to position the overlays corresponding to the invisible virtual objects from the perspective of each per-bay FOV so that those invisible virtual objects line up with the overlays of corresponding visible virtual objects or visible virtual target objects in other bays.

Given these transforms, visible virtual objects or visible virtual target objects and corresponding invisible virtual objects within the FOV of a particular bay will have approximately the same position relative to that bay and to the shared display device as those visible and invisible virtual objects would have had in the case described in Section 2.2.1 of this document with respect to the use of individual virtual viewports for each bay. As with the per-bay virtual viewport implementations, such implementations provide multiple location-dependent (e.g., bays) perspective correctness relative to the shared display device, thereby enabling simultaneous interaction with the background scene (and various visible and invisible virtual objects) among any or all of the locations or bays.

2.3 Grouping Bays:

In various implementations, one or more bays are grouped (i.e., groups including one or more bays) for various purposes, such as, for example, rendering one or more visible virtual objects into the virtual viewports of bay in that group while positioning invisible versions of that visible virtual object into the other bays in the group. In various implementations, a user interface or the like is provided to enable users in any bay to join a group, initiate formation of a group, invite other bays to join a group, leave a group, etc. One advantage of grouping bays is to enable interaction between those bays, e.g., via a common target mode or the like that enables users in each bay within in a group of multiple bays to launch physical objects towards a virtual target object rendered relative to the FOV of one of the bays in the group or rendered relative to the background FOV. In the case of a one bay group, the user in that bay will see the overall background scene on the shared display device and any physical objects will be rendered into the background scene from the perspective of that viewport. However, corresponding invisible objects may not be positioned into viewports associated with other bays not in the group, although such positioning is enabled, if desired.

Groups of bays need not be contiguous. For example, consider a linear sequence of bays (e.g., bays 1, 2, 3, 4, 5 and 6). In this linear sequence of bays, a group may be formed by a subset of bays (e.g., bays 1, 2, 4 and 5), with bay 3 either not active, forming its own single bay group, or joining another group (e.g., a group formed from bays 3 and 6). In this exemplary grouping scenario, common target mode may be optionally disabled to prevent bays 1, 2, 4 and 5 from launching physical objects across the physical space in front of bay 3. In various implementations, common target mode may be enabled for groups of 2 or 3 contiguous bays within a row of bays, and may be optionally disabled for contiguous groups of 4 or more bays within a row of bays. However, enabling or disabling of common target mode for groups is not a physical or computational limitation of the Shared Perspective Renderer and is provided as an optional feature to limit physical objects from being launched towards a virtual target object at an angle that causes the physical object to cross into the physical extents of another bay.

2.4 Perspective Correct Display of Background Virtual Environment:

In general, the background viewport covers the entire shared display device. As such, in various implementations, the virtual environment rendered on the shared display device is a perspective correct 2D view of a 3D scene. For example, typical rendering of 3D scenes onto a 2D display device operate to render such scenes using a single vanishing point near a horizontal and/or vertical center (or other defined location) of that 2D display device.

In various implementations, various optional constraints on the virtual environment are included to improve realism of the virtual environment from the perspective of users as those users get closer to edges of the shared display device. For example, objects with 3D perspectives (e.g., square building) can placed far enough in the background so that only a front face is visible since users (including on the far left and right of the shared display device) will see the same thing as opposed to a real 3D scene where a user on the left may see the left and front sides of a building while a user on the right may see the right and front sides of a building. As such, objects having such perspective issues may be positioned within the virtual environment in a way that improves realism from a user perspective. Further, in various implementations, the Shared Perspective Renderer avoids placing virtual objects near the left and right edges of the background scene to avoid potential warpage of those virtual objects as an artifact resulting from rendering perspective projections on the wide aspect ratio of the shared display device.

Further, objects that are curved, or that are approximately spherical or cylindrical may look generally the same from each of the different perspectives of the individual bays. As such, curved, round and cylindrical objects may be placed in the near foreground of the virtual environment without adversely affecting realism from a user perspective. Similarly, flat objects (e.g., virtual targets such as dart boards) will tend to look generally the same from each of the different perspectives of the individual bays. As such, flat objects may also be placed in the near foreground of the virtual environment without adversely affecting realism from a user perspective. In other words, various optional constraints are applied when generating the virtual environment to ensure that the virtual environment looks generally realistic from each of the perspectives of the different bays. This can be achieved, for example, by using particular object shapes (e.g., round, spherical, flat, etc.) when rendering such objects into a foreground of the virtual environment being presented on the shared display device, while more complex shapes or objects can be rendered and presented as approximately flat objects when placed in the far background of the virtual environment.

2.5 Per-Bay Physical Object Tracking:

In various implementations, the Shared Perspective Renderer applies any of a variety of known object detection and tracking modalities to track physical objects (also including lasers and optical beams) launched (e.g., thrown, hit, rolled, kicked, pushed, shot, etc.) from any physical region towards the shared display device. Further, multiple different physical objects may be launched, and tracked, either or both concurrently and sequentially from any one or more of the bays. The resulting tracking information is used to compute trajectories of those physical objects. Such object detection and tracking modalities are well-known to those skilled in the art and will not be described herein. Examples of such physical objects include, but are not limited to, golf balls, baseballs, footballs, soccer balls, hockey pucks, bowling balls, snowballs, rocks, flying discs, stuffed animal toys, paintballs, arrows, missiles, bullets, or any other physical object, also including lasers and optical beams, that can be launched from any physical region towards the shared display device.

In various implementations, this object tracking includes consideration of physical objects (e.g., baseball bat, hockey stick, bow, etc.) used to interact (e.g., hit, shoot, etc.) with physical objects launched towards the shared display device. For example, consider a baseball bat hitting a baseball. In this case, the Shared Perspective Renderer applies any of a variety of known object detection and tracking modalities to determine factors such as ball speed when hit, bat speed when hitting the ball, spin of the ball (either before or after hitting the baseball), bat weight or other physical characteristics, etc., for use in a physics-based determination of the interactions and trajectories of both the bat and the baseball. Again, such object detection and tracking modalities are well-known to those skilled in the art and will not be described herein.

In other words, for one or more of the viewports, a physical object is launched from the corresponding bay towards the shared display device. The Shared Perspective Renderer then tracks that physical object and calculates a trajectory of that physical object. The 3D positions of the physical object during the trajectory are fed into the rendering engine, the rendering engine then adjusts the position of the corresponding visible virtual object based on a perspective correct projection. As such, physical objects launched towards the shared display device appear to continue into the virtual environment being presented on the shared display device via this rendering of the corresponding visible virtual object. Optionally, as discussed, separate versions (for each of one or more of the other bays) of invisible virtual objects corresponding to each visible virtual object may be concurrently positioned into the same virtual environment from the perspective or vanishing point associated with the viewport or FOV of each of the other bays.

In other words, for each bay virtual viewport, the Shared Perspective Renderer calculates the trajectory of any physical object launched from that bay. The Shared Perspective Renderer can then convert that trajectory into coordinates of the virtual environment being presented on the shared display device relative to the perspective or vanishing point associated with that bay. The Shared Perspective Renderer then applies that trajectory to render a virtual version of the physical object into the virtual environment.

In various implementations, trajectories of visible virtual objects (and, optionally, corresponding invisible virtual objects) computed by the Shared Perspective Renderer are optionally modified based on virtual weather conditions (e.g., wind speed, humidity, rain, temperature, etc.). In related implementations the Shared Perspective Renderer optionally modifies trajectories of visible virtual objects (and corresponding invisible virtual objects) corresponding to launched physical objects based on additional factors including, but not limited to, speed of the physical object, launch angle of the physical object, spin of the physical object, real or simulated gravity fields, speed and other physical characteristics of physical objects used to hit or otherwise launch those physical objects, etc.

In various implementations, the Shared Perspective Renderer includes a net or other capture mechanism (i.e., a “physical object capture mechanism”) to optionally catch or otherwise stop physical objects launched towards the shared display device before those physical objects can physically impact the shared display device. In various implementations, the shared display device, e.g., a relatively fine reflective net or the like, can itself be used as both a projection surface and capture mechanism to catch or otherwise stop physical objects launched towards the shared display device when those physical objects physically impact the shared display device. In cases where the shared display device involves in-air projections such as, for example, conventional laser and particle volumetric projection systems or projections onto fog or water vapor fields or the like, physical objects can simply pass through the plane of the projection. In various implementations, one or more physical object capture mechanisms are optionally positioned to prevent physical objects launched from within one bay from entering another bay.

2.6 Positioning the Same Virtual Object in Multiple Viewports:

Physical objects launched (e.g., thrown, hit, rolled, pushed, shot, etc.) from any bay towards the shared display device are rendered onto or into the virtual environment as visible virtual objects within the corresponding virtual viewport based on the trajectory determined from the various tracking modalities applied by the Shared Perspective Renderer, and relative to the vanishing point associated with the corresponding virtual viewport. In addition, these launched physical objects are optionally positioned as corresponding invisible virtual objects in one or more of the other virtual viewports. In other words, separate instances of the same virtual object are optionally positioned and rendered in each of a plurality of different viewports within the overall virtual environment being rendered on the shared display device. One of these instances of the same virtual object is visible in the viewport corresponding to the physical region from which that object was launched, while the remaining instances of the same virtual object are optionally positioned as corresponding invisible virtual objects within the remaining viewports. Such rendering and/or positioning of visible and invisible virtual objects is at least partially based on a computed trajectory of the corresponding physical object (as determined from any of a plurality of motion tracking techniques known to those skilled in the art) and a perspective or vanishing point associated with each of the different viewports.

Consequently, in various implementations, there is nothing in any bay viewport other than visible virtual target objects, visible virtual objects and invisible virtual objects corresponding to visible virtual objects existing in other bay viewports. Everything else exists within the overall background scene (e.g., the overall virtual environment). In addition, visible objects existing only in the overall background scene of the virtual environment (e.g., a blimp, golf cart, etc.) can be collidable (See Section 2.7 of this document) from one or more of the viewports when invisible versions of those visible objects are optionally included in the virtual viewports of one or more of the individual bays based on the perspective or vanishing point associated with those virtual viewports. In other words, some fixed or moving visible objects exist as visible virtual objects in the overall background scene of the virtual environment rather than in individual viewports and may be treated the same as visible virtual objects existing within a particular virtual viewport.

As discussed, each virtual viewport has its own different vanishing point relative to the FOV of that virtual viewport. As such, visible or invisible virtual objects further in the distance in any particular virtual viewport will converge towards a vanishing point that differs for each of the location-dependent perspective viewports or FOV's. As such, the location of invisible virtual objects in each viewport is adjusted to line up with the visible version of such objects in a particular one of the viewports based on the particular vanishing point associated with each viewport. In other words, any object visibly rendered into any viewport (including bay viewports or FOV's and the overall background viewport) is rendered relative to the perspective of that viewport and then optionally invisibly positioned into one or more of the other bay viewports or FOV's to account for the perspective those other bays relative to the bay in which that object is visible. Further, trajectories of visible virtual objects and invisible virtual objects are computed in 3D scene coordinates and passed to the rendering engine which converts them to 2D coordinates that are perspective correct. In various implementations, the rendering engine also applies conventional Z-order computations for determining whether any visible virtual objects fully or partially occlude any other visible virtual objects. Such rendering operations are well known to those skilled in the art and will not be described in detail herein.

For example, when a user looks at the overall virtual environment, a single target (e.g., a visible virtual object not associated with an actual physical object) may be visible in a particular location (e.g., that target is rendered relative to a particular horizontal and vertical pixel location) within the background scene of the virtual environment with respect to the virtual viewport of a corresponding bay (or with respect to the overall background viewport). As discussed in further detail in Section 2.6 of this document, visible virtual objects such as that target are positioned as corresponding invisible objects into separate locations on the large virtual environment corresponding to the virtual viewports of one or more of the other bays. The invisible positioning of these target objects is based on a computed perspective transformation of the view from each viewport such that it lines up with the visible virtual object in its viewport.

In other words, in various implementations, a virtual object (whether or not it is associated with an actual physical object) is visible in a certain location on the shared display device relative to a given bay's viewport or within the background viewport of the overall virtual environment. The Shared Perspective Renderer optionally invisibly positions instances of that virtual object in other viewports from a collision standpoint such that it appears to be in the same location on the shared display device (relative to Z-computations and transforms relating to the vanishing points of the other virtual viewports). This enables visible virtual objects from the various viewports to accurately collide with visible virtual objects in other viewports (or different visible virtual objects in the same virtual viewport or FOV) by determining whether a collision has occurred in virtual 3D space (i.e., via the rendering engine) between a visible virtual object in one virtual viewport and another virtual object (visible or invisible) in that same viewport.

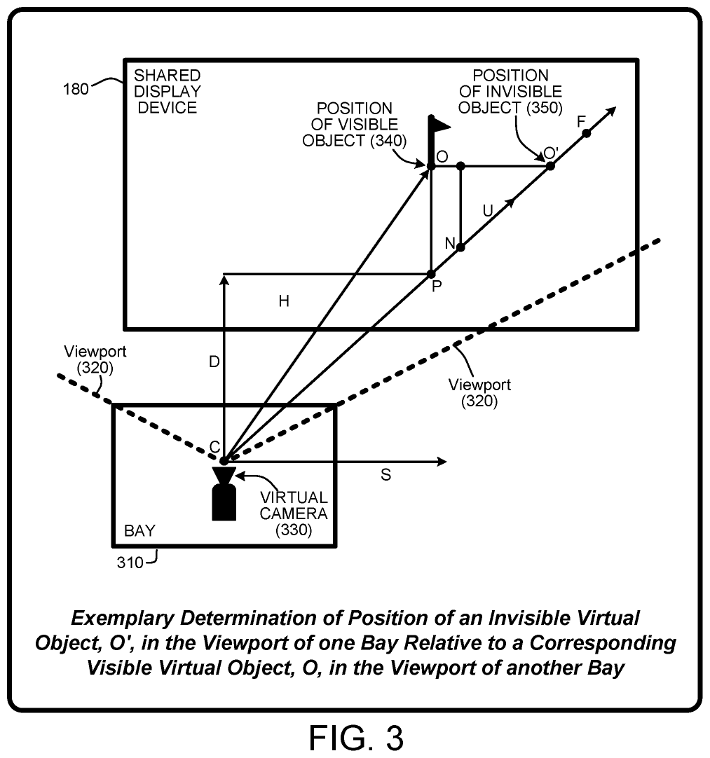

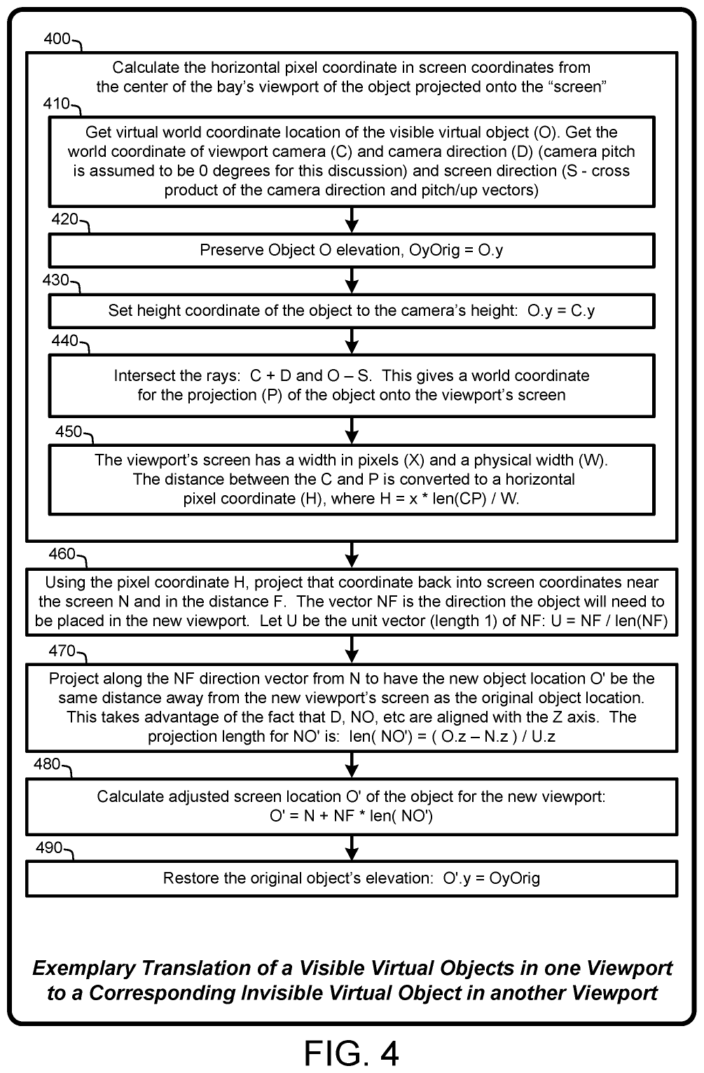

More specifically, as illustrated by FIG. 3, when considered in combination with FIG. 4, from the perspective of a virtual camera 330 and corresponding virtual viewport 320 of a particular bay 310, the Shared Perspective Renderer considers a visible virtual object O and projects (in graphics space via the rendering engine) a position of O down onto the shared display device (e.g., into the overall virtual environment being presented on the shared display device 180. The Shared Perspective Renderer then calculates an offset for each invisible virtual object corresponding to a visible virtual object in another viewport from the vanishing point (e.g., at or near the center) of a particular bay's viewport. The diagram of FIG. 3 is provided only for purpose of explanation and is not intended to limit the determination of such offsets to the exact process illustrated by FIG. 3. For example, beyond the schematic provided by FIG. 3, many mathematical techniques and rendering operations exist for shifting or offsetting positions of virtual objects based on changes to perspectives or vanishing points. As such, those skilled in the art will understand that other techniques for shifting or offsetting the positions of virtual objects based on shifting or changing vanishing points or the like may be applied without departing from the scope of the Shared Perspective Renderer described herein.

FIG. 4 illustrates an exemplary translation of a visible virtual object in one viewport to a corresponding invisible virtual object in another viewport. As with FIG. 3, the flow diagram of FIG. 4 is provided only for purpose of explanation and is not intended to limit the determination of such offsets to the exact process illustrated by FIG. 4. For example, beyond the flow diagram provided by FIG. 4, many mathematical techniques and rendering operations exist for shifting or offsetting positions of virtual objects based on changes to perspectives or vanishing points. As such, those skilled in the art will understand that other techniques for shifting or offsetting the positions of virtual objects based on shifting or changing vanishing points or the like may be applied without departing from the scope of the Shared Perspective Renderer described herein.

When considered in combination with FIG. 3, box 400 of FIG. 4 generally calculates a horizontal pixel coordinate in screen coordinates from the center of a bay's viewport of object O (i.e., position of a visible virtual object) projected onto the shared display device. The intent of this operation is generally to project the point O down to P to get a pixel coordinate H to obtain a screen coordinate for the shared display device relative to the bay's viewport, then to subsequently convert that screen coordinate back to world coordinates (see box 460). Further, H is projected back into world coordinates near (N) the screen (i.e., graphics space representing the shared display device) and far (F) from the screen to obtain a vector that extends out infinitely into the screen, thereby providing a direction from the vector between N and F. Then, the direction vector from O to P has a length. In general, O′ (i.e., position of an invisible virtual object corresponding to the object at position O) is a location that has the same distance to the screen as O did, but O′ is projected outwards enable the invisible virtual object in the corresponding bay's viewport to line up with the visible virtual object that's in a different viewport.

More specifically, with respect to FIG. 3 and FIG. 4, box 400 shows exemplary steps for calculating the horizontal pixel coordinate in screen coordinates from the center of the bay's viewport of the object O projected onto the screen. Boxes 410 through 450 detail this process. For example, as illustrated by box 410, the Shared Perspective Renderer obtains a virtual world coordinate location (e.g., graphics space within the rendering engine) of the visible virtual object (O). The Shared Perspective Renderer then obtains the world coordinate of virtual viewport camera (C) and camera direction (D) (camera pitch is assumed to be 0 degrees for this discussion) and screen direction (S—cross product of the camera direction and pitch/up vectors). Next, as illustrated by box 420, the Shared Perspective Renderer operates to preserve Object O's original y elevation relative to the world coordinates, e.g., OyOrig=O.y.

Next, as illustrated by box 430, the Shared Perspective Renderer continues by setting a height coordinate of the object O to the virtual height of the virtual camera, e.g., O.y=C.y. Given this information, the Shared Perspective Renderer then intersects rays C+D and O−S as illustrated by box 440. This gives a world coordinate for the projection (P) of the object O onto the viewport's screen (i.e., onto the particular segment of overall virtual environment corresponding to that virtual viewport). As illustrated by box 450, the viewport's screen has a width in pixels (X) and a physical width (W). The distance between the C and P is converted to a horizontal pixel coordinate (H), as determined by H=x*len(CP)/W.

The Shared Perspective Renderer then projects (see box 460) the pixel coordinate H back into world coordinates near the screen N and in the distance F. The vector NF is the direction the object O′ will be placed in the new viewport. For this purpose, let U be the unit vector (length 1) of NF, e.g., U=NF/len(NF). Next, as illustrated by box 470, the Shared Perspective Renderer Projects along the NF direction vector from N to set the new object location O′ to be the same distance away from the new viewport's screen as the original object O location. The Shared Perspective Renderer takes advantage of the fact that D, NO, etc., are aligned with the Z-axis. The projection length for NO′ can be obtained relative to the Z-axis by, for example, len(NO′)=(O.z−N.z)/U.z. As illustrated by box 480, this then enables the Shared Perspective Renderer to calculate the adjusted screen location O′ of the object for the new viewport by determining, for example, O′=N+NF*len(NO′). Finally, as illustrated by box 490, the Shared Perspective Renderer restores the original object's elevation to O′ by setting O′.y=OyOrig to complete the translation of the position of a visible virtual object in one virtual viewport to a corresponding invisible virtual object in another viewport.

2.7 Collision Detections and Handling:

By tracking the positions of some or all visible virtual objects and invisible virtual objects in the virtual viewports of any group of bays, the Shared Perspective Renderer determines whether any such objects exist in the same location (i.e., same x, y and z coordinates in graphics space within the rendering engine) at approximately the same time. If such visible and invisible objects do exist in the same space and time, then the Shared Perspective Renderer determines that a collision has occurred. In other words, based on their computed trajectories and corresponding positions as a function of time, collision detections between different visible virtual objects (corresponding to different physical objects or virtual target objects) and corresponding invisible virtual objects in one or more of the virtual viewports are tracked in real-time. Such collision detections are used for various purposes (e.g., scoring, user notifications, virtual object trajectory modifications, etc.).

For example, in one implementation, different viewports associated with a group of bays are presented with a visible virtual target object (e.g., a dart board) in the virtual viewport of one of the bays. Users in any of the bays can then launch physical objects towards that visible virtual object. As discussed, the visible virtual target object is positioned relative to the virtual viewport or FOV of one of the bays (or relative to the overall background viewport). An invisible version of that visible virtual target object is then positioned in one or more of the other virtual viewports or FOV's. Further, as discussed, a visible virtual version of launched physical objects is rendered into the virtual viewport corresponding to the bay from which that object was launched. Optionally, invisible virtual versions of that visible virtual object are positioned into the virtual viewports of the other bays in the group.

For example, consider bays A, B and C. A visible target object O will be rendered as a visible virtual object into one of the bays (e.g., bay B) and optionally positioned as a corresponding invisible virtual object into one or more of the other bays (e.g., bays A and C). Invisible virtual objects are transformed (e.g., scaled and oriented) and positioned based on the physical location or region of the viewport into which these invisible objects are positioned relative to the viewport into which those virtual objects (also including virtual target objects) are visible. By tracking each visible virtual object (also including visible virtual target objects) and each invisible virtual object across all of the virtual viewports for the bays in the group, the Shared Perspective Renderer determines whether any such objects have virtually collided and then acts accordingly (e.g., generation of scoring data, and/or any desired combination of audio and/or visual responses such as score updates, sounds, explosions, virtual environment changes, trajectory changes, etc.) in response to collision detections (and/or to collision misses where a virtual collision attempted by a user fails to occur).

In various implementations, the Shared Perspective Renderer acts to mitigate timing conflicts with respect to virtual collisions. For example, if the Shared Perspective Renderer determines that visible virtual objects generated from two different bays (e.g., physical balls concurrently thrown from each of those bays) simultaneously or near simultaneously hit the same virtual target object (or the invisible version of that virtual target object), the Shared Perspective Renderer can determine if one or both user's are credited with the collision for scoring or other purposes (e.g., audio and/or visual effects based on detected collisions).

2.8 Considerations for Local and Remote Computing Resources:

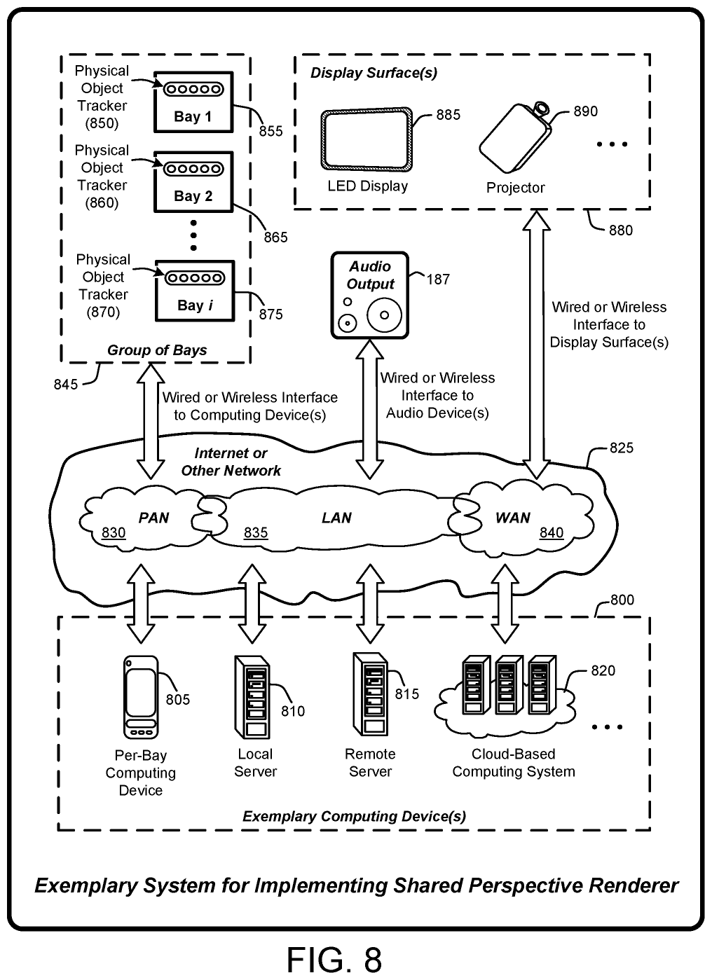

In general, the Shared Perspective Renderer may be implemented by any combination of one or more local (e.g., per-bay) computing devices, local or remote servers, cloud-based computing systems, etc., (see discussion of FIG. 8 in Section 4.0 of this document). Whether or not the Shared Perspective Renderer is implemented by one local or remote computing device, server, or cloud-based computing system, or by any desired combination or number of any or all such devices or systems may be a function of communication bandwidth, latency, and computing power of such computing devices and systems.

For example, in various implementations, the Shared Perspective Renderer is operational via a separate per-bay computing device for each bay in communication with a local or remote server or cloud-computing system. In such implementations, physical object tracking in a particular bay may be performed via one or more detection and tracking sensors in communication with a corresponding per-bay computing device. In addition, physical or virtual object trajectory computations and rendering of corresponding visible virtual objects for the virtual viewport of each corresponding bay may also be implemented by the corresponding per-bay computing device. Each per-bay computing device may report physical or virtual object trajectory computations to any of the other per-bay computing devices and any local or remote server or cloud-computing system. Such reporting enables these other per-bay computing devices and local or remote server or cloud-computing system to position offset invisible virtual objects (based on the virtual viewports associated with each bay) corresponding to the visible virtual objects in any other bay.

Tracking and collisions between different visible virtual objects and/or visible and invisible virtual objects in any bay can then be determined by any or all of the per-bay computing devices and local or remote server or cloud-computing system. Responses to such collisions for trajectory modifications and/or scoring purposes may then be performed by any or all of the per-bay computing devices and local or remote server or cloud-computing system and optionally reported to any or all of the other per-bay computing devices and local or remote server or cloud-computing system.

Clearly, as will be well-understood by those skilled in the art, any or all of the features described throughout this document can be implemented via any desired combination of computational and communications resources. In particular, any one or more sufficiently capable (e.g., sufficient computational capacity, sufficient communications bandwidth, sufficient latency, etc.) computing devices, servers, or cloud-computing systems may be used to implement any or all of the features of the Shared Perspective Renderer as described herein without departing from the intended scope of the concepts described. As such, modifying, adapting, combining, networking, etc., communications and interactions between any one or more such computing devices, servers or cloud-computing systems for implementing any or all of the features of the Shared Perspective Renderer does not limit the subject matter of the Shared Location-Dependent Perspective Renderer as described herein.

3.0 Operational Summary of the Shared Perspective Renderer:

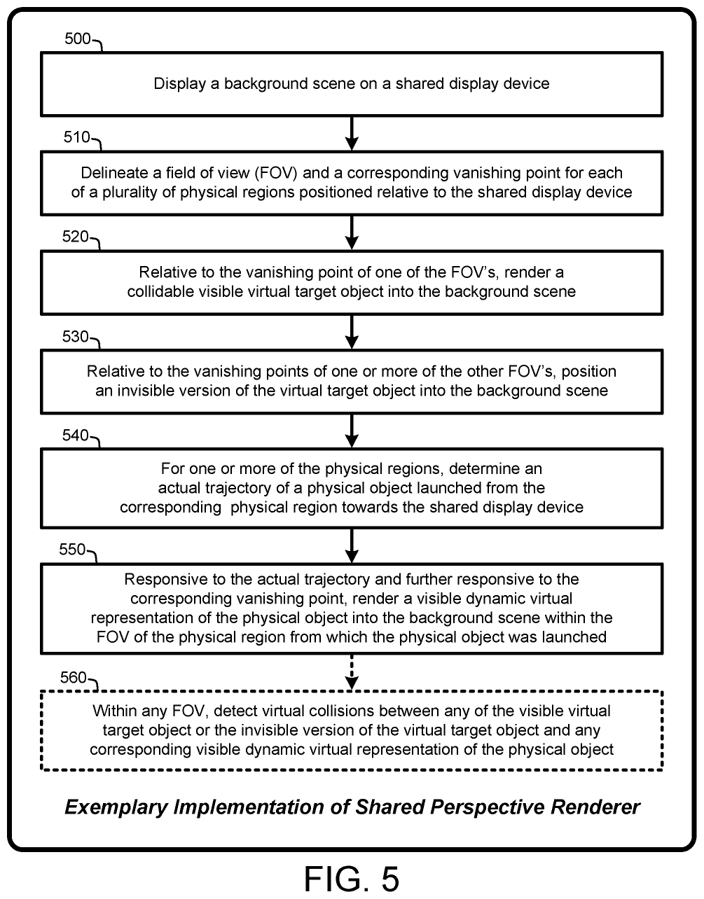

The processes described above with respect to FIG. 1 through FIG. 4, and in further view of the detailed description provided above in Sections 1 and 2, are illustrated by the general operational flow diagrams of FIG. 5 through FIG. 7. In particular, FIG. 5 through FIG. 7 provide exemplary operational flow diagrams that summarize the operation of some of the various implementations of the Shared Location-Dependent Perspective Renderer. FIG. 5 through FIG. 7 are not intended to provide an exhaustive representation of all of the various implementations of the Shared Perspective Renderer described herein, and the implementations represented in these figures are provided only for purposes of explanation.

Further, any boxes and interconnections between boxes that may be represented by broken or dashed lines in FIG. 5 through FIG. 7 represent optional or alternate implementations of the Shared Perspective Renderer described herein, and any or all of these optional or alternate implementations may be used in combination with other alternate implementations that are described throughout this document.

In general, as illustrated by FIG. 5, in various implementations, the Shared Location-Dependent Perspective Renderer provides various computer-based techniques for rendering an interactive virtual environment. For example, in one implementation, the Shared Location-Dependent Perspective Renderer begins operation by applying one or more computing devices to display (500) a background scene on a shared display device. In addition, the Shared Location-Dependent Perspective Renderer delineates (510) or otherwise defines a field of view (FOV) and a corresponding vanishing point for each of a plurality of physical regions positioned relative to the shared display device. Then, relative to the vanishing point of one of the FOV's, the Shared Location-Dependent Perspective Renderer renders (520) a collidable visible virtual target object into the background scene. Further, relative to the vanishing points of one or more of the other FOV's, the Shared Location-Dependent Perspective Renderer positions (530) an invisible version of the virtual target object into the background scene. In addition, for one or more of the physical regions, the Shared Location-Dependent Perspective Renderer determines (540) an actual trajectory of a physical object launched from the corresponding physical region towards the shared display device. Finally, responsive to the actual trajectory and further responsive to the corresponding vanishing point, the Shared Location-Dependent Perspective Renderer renders (550) a visible dynamic virtual representation of the physical object into the background scene within the FOV of the physical region from which the physical object was launched. In various implementations, within any FOV, the Shared Location-Dependent Perspective Renderer optionally detects (560) virtual collisions between any of the visible virtual target object or the invisible version of the virtual target object and any corresponding visible dynamic virtual representation of the physical object.

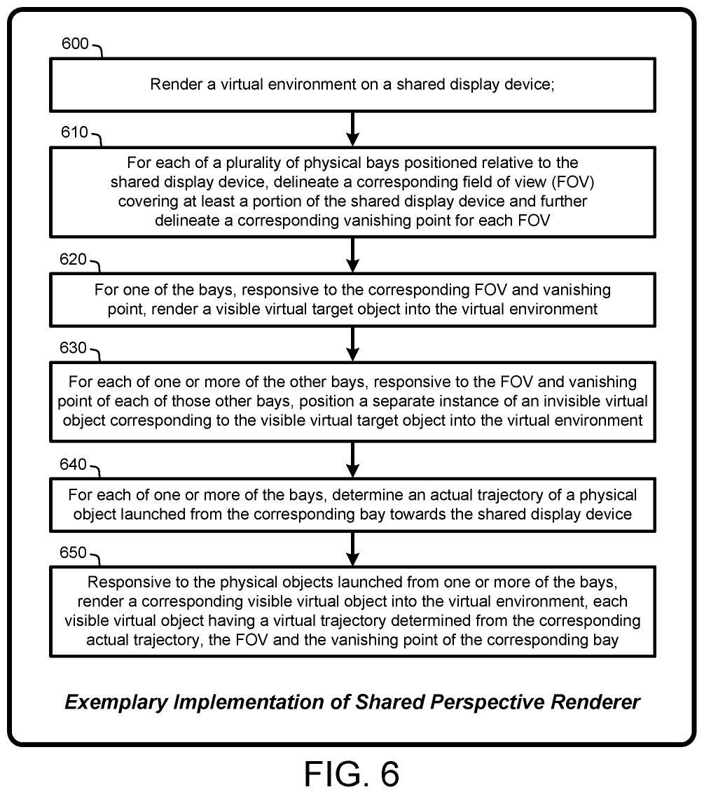

Similarly, as illustrated by FIG. 6, in various implementations, the Shared Location-Dependent Perspective Renderer is instantiated as a system that includes a hardware processor device, a shared display device and a memory device storing machine-readable instructions which, when executed by the hardware processor device, cause the hardware processor device to render (600) a virtual environment on the shared display device. In addition, for each of a plurality of physical bays positioned relative to the shared display device, the Shared Location-Dependent Perspective Renderer delineates (610) or otherwise defines a corresponding field of view (FOV) covering at least a portion of the shared display device and further delineates a corresponding vanishing point for each FOV. Further, for one of the bays, responsive to the corresponding FOV and vanishing point, the Shared Location-Dependent Perspective Renderer renders (620) a visible virtual target object into the virtual environment. Then, for each of one or more of the other bays, responsive to the FOV and vanishing point of each of those other bays, the Shared Location-Dependent Perspective Renderer positions (630) a separate instance of an invisible virtual object corresponding to the visible virtual target object into the virtual environment. In addition, for each of one or more of the bays, the Shared Location-Dependent Perspective Renderer determines (640) an actual trajectory of a physical object launched from the corresponding bay towards the shared display device. Finally, responsive to the physical objects launched from one or more of the bays, the Shared Location-Dependent Perspective Renderer renders (650) a corresponding visible virtual object into the virtual environment, each visible virtual object having a virtual trajectory determined from the corresponding actual trajectory, the FOV and the vanishing point of the corresponding bay.

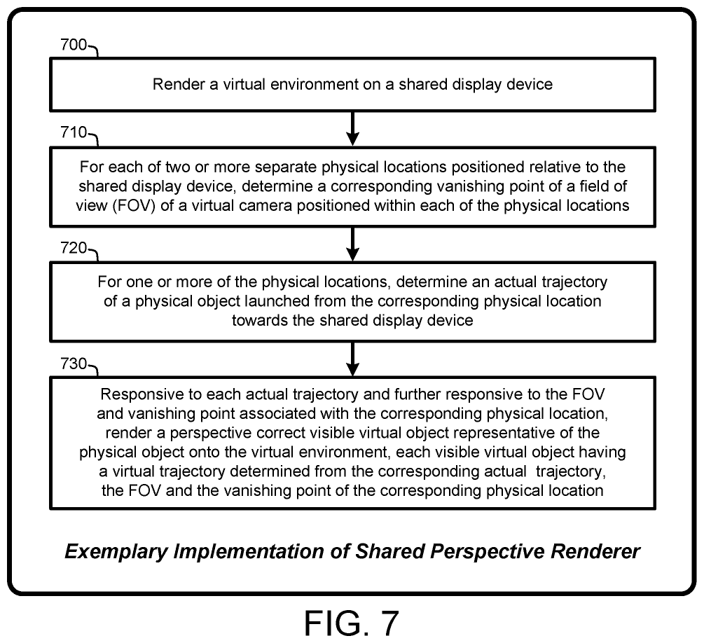

Similarly, as illustrated by FIG. 7, in various implementations, the Shared Location-Dependent Perspective Renderer is instantiated as a system that includes a hardware processor device, a shared display device and a memory device storing machine-readable instructions which, when executed by the hardware processor device, cause the hardware processor device to render (700) a virtual environment on the shared display device. In addition, for each of two or more separate physical locations positioned relative to the shared display device, the Shared Location-Dependent Perspective Renderer determines (710) a corresponding vanishing point of a field of view (FOV) of a virtual camera positioned within each of the physical locations. Further, for one or more of the physical locations, the Shared Location-Dependent Perspective Renderer determines (720) an actual trajectory of a physical object launched from the corresponding physical location towards the shared display device. Finally, responsive to each actual trajectory and further responsive to the FOV and vanishing point associated with the corresponding physical location, the Shared Location-Dependent Perspective Renderer renders (730) a perspective correct visible virtual object representative of the physical object onto the virtual environment, each visible virtual object having a virtual trajectory determined from the corresponding actual trajectory, the FOV and the vanishing point of the corresponding physical location.

4.0 Exemplary Operating Environments:

The Shared Location-Dependent Perspective Renderer implementations described herein are operational within numerous types of general purpose or special purpose computing system environments or configurations. For example, as discussed in Section 2.8 of this document any combination of one or more local (e.g., per-bay) computing devices, local or remote servers, cloud-based computing systems, or any other computing devices can be applied in combination with various tracking, networking and communications modalities to implement the Shared Perspective Renderer.

For example, as illustrated by FIG. 8, the processes enabled by the Shared Perspective Renderer can be implemented by instantiating the Shared Perspective Renderer on one or more computing devices 800 (e.g., per-bay computing device 805, local server 810, remote server 815, cloud-based computing system 820, or any other computing device or system having sufficient computational resources. Some or all of these computing devices are in communication with each other and/or in communication with physical object trackers (e.g., 850, 860 and/or 870) in the bays (e.g., 855, 865 and 875) of a group of bays 845. Such communications are enabled via any of a wide range of communication and networking technologies. For example, such communications are enabled via the internet or other network 825, and include networks such as, for example, conventional wired or wireless networks including personal area networks (PAN) 830, local area networks (LAN) 835, wide area networks (WAN) 840, etc., using any desired network topology (e.g., star, tree, etc.).

As discussed in further detail throughout Section 2 of this document, the Shared Perspective Renderer operates on any combination of any or all of the aforementioned computing devices 800 and networks 825 to receive physical object tracking information from the group of bays 845. The Shared Perspective Renderer then renders visible and positions invisible virtual representations of those physical objects into virtual viewports associated with each of the bays in the group of bays 845. These rendered objects are then presented, along with an overall virtual environment, on a shared display device or surface 880 (e.g., LED display 885, projector 890, etc.). In the case of multiple projectors being applied to present the overall virtual environment on the shared display device, conventional edge blending software and/or hardware is employed to ensure that the images from the individual projectors are properly blended and aligned in regions of the shared display device where the projections from two or more projectors join or overlap. Such edge-blending techniques are well-known to those skilled in the art and will not be described in detail herein. In various implementations, audio device 187 provides audio outputs received from any of the computing devices 800.

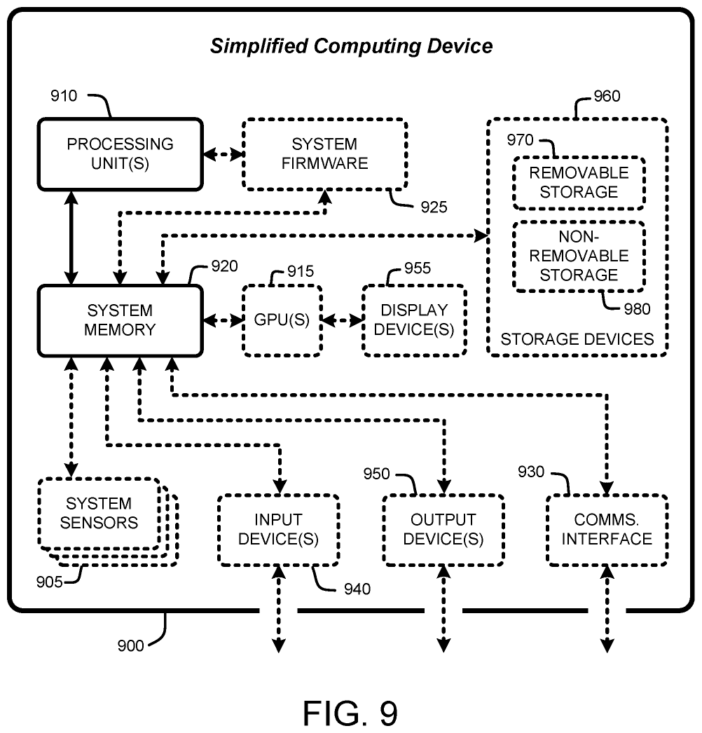

For purposes of discussion, FIG. 9 illustrates a simplified example of a general-purpose computer system (e.g., per-bay computing devices, local and remote servers, cloud-based computing systems, etc.) on which various implementations and elements of the Shared Location-Dependent Perspective Renderer, as described herein, may be implemented. FIG. 9 is not intended to illustrate every component of a computer system as such components are well-known to those skilled in the art. Any boxes that are represented by broken or dashed lines in the simplified computing device 900 shown in FIG. 9 represent alternate implementations of the simplified computing device. As described below, any or all of these alternate implementations may be used in combination with other alternate implementations that are described throughout this document.

The simplified computing device 900 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the Shared Location-Dependent Perspective Renderer implementations described herein, the device should have a sufficient computational capability and system memory to enable basic computational operations. In particular, the computational capability of the simplified computing device 900 shown in FIG. 9 is generally illustrated by one or more processing unit(s) 910, and may also include one or more graphics processing units (GPUs) 915, either or both in communication with system memory 920. The processing unit(s) 910 of the simplified computing device 900 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 900 may also include other components, such as, for example, a communications interface 930. The simplified computing device 900 may also include one or more conventional computer input devices 940 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 900 and with any other component or feature of the Shared Location-Dependent Perspective Renderer, including input, output, control, feedback, and response to one or more users or other devices or systems associated with the Shared Location-Dependent Perspective Renderer, are enabled by a variety of Natural User Interface (NUI) scenarios. The NUI techniques and scenarios enabled by the Shared Location-Dependent Perspective Renderer include, but are not limited to, interface technologies that allow one or more users user to interact with the Shared Location-Dependent Perspective Renderer in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 940 or system sensors 905. Such NUI implementations are also enabled by the use of various techniques including, but not limited to, information derived from system sensors 905 or other input devices 940 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices.

Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the Shared Location-Dependent Perspective Renderer.

However, the aforementioned exemplary NUI scenarios may be further augmented by combining the use of artificial constraints or additional signals with any combination of NUI inputs. Such artificial constraints or additional signals may be imposed or generated by input devices 940 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the Shared Location-Dependent Perspective Renderer.

The simplified computing device 900 may also include other optional components such as one or more conventional computer output devices 950 (e.g., display device(s) 955, audio output devices, video output devices, devices for transmitting wired or wireless data transmissions, and the like). Typical communications interfaces 930, input devices 940, output devices 950, and storage devices 960 for general-purpose computers are well known to those skilled in the art, and will not be described in detail herein.

The simplified computing device 900 shown in FIG. 9 may also include a variety of computer-readable media. Computer-readable media can be any available media that can be accessed by the computing device 900 via storage devices 960, and include both volatile and nonvolatile media that is either removable 970 and/or non-removable 980, for storage of information such as computer-readable or computer-executable instructions, data structures, subprograms, program modules, or other data.

Computer-readable media includes computer storage media and communication media. Computer storage media refers to tangible computer-readable or machine-readable media or storage devices such as digital versatile disks (DVDs), Blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, subprograms, program modules, and the like, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. The terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various Shared Location-Dependent Perspective Renderer implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware 925, hardware, or any combination thereof to control a computer to implement the disclosed subject matter. The term “article of manufacture” as used herein is intended to encompass a computer program accessible from any computer-readable device, or media.

The Shared Location-Dependent Perspective Renderer implementations described herein may be further described in the general context of computer-executable instructions, such as a program and subprograms, being executed by a computing device. Generally, programs and subprograms include routines, programs, objects, components, data structures, and the like, that perform particular tasks or implement particular abstract data types. The Shared Location-Dependent Perspective Renderer implementations may also be practiced in distributed computing environments where tasks are performed by one or more remote processing devices, or within a cloud of one or more devices, that are linked through one or more communications networks. In a distributed computing environment, programs and subprograms may be located in both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

6.0 Other Implementations:

The foregoing description of the Shared Location-Dependent Perspective Renderer has been presented for the purposes of illustration and description. It is not intended to be exhaustive or to limit the claimed subject matter to the precise form disclosed. Many modifications and variations are possible in light of the above teaching. Further, any or all of the aforementioned alternate implementations may be used in any combination desired to form additional hybrid implementations of the Shared Location-Dependent Perspective Renderer. It is intended that the scope of the Shared Location-Dependent Perspective Renderer be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the Shared Location-Dependent Perspective Renderer described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known to enable such interactions.

What is claimed is:

1. A method, implemented by a computing device comprising a processing unit and a memory, the method comprising:
displaying a background scene on a shared display device;
delineating a field of view (FOV) and a corresponding vanishing point for each of a plurality of physical regions positioned relative to the shared display device;
relative to the vanishing point of one of the FOV's, rendering a collidable visible virtual target object into the background scene;
relative to the vanishing points of one or more of the other FOV's, positioning an invisible version of the virtual target object into the background scene;
for one or more of the physical regions, determining an actual trajectory of a physical object launched from the corresponding physical region towards the shared display device; and
responsive to the actual trajectory and further responsive to the corresponding vanishing point, rendering a visible dynamic virtual representation of the physical object into the background scene within the FOV of the physical region from which the physical object was launched.

2. The method of claim 1 further comprising, within any FOV, detecting virtual collisions between any of the visible virtual target object or the invisible version of the virtual target object and any corresponding visible dynamic virtual representation of the physical object.

3. The method of claim 2 further comprising, responsive to any virtual collision, modifying a virtual trajectory of any of the corresponding visible virtual target object, the corresponding invisible version of the virtual target object and the corresponding visible dynamic virtual representation of the physical object.

4. The method of claim 1 further comprising a user interface for selecting the background scene from a plurality of different background scenes

5. The method of claim 1 further comprising a user interface for selecting one or more of the collidable visible virtual target objects rendered into the background scene from a plurality of different virtual target objects.

6. The method of claim 1 further comprising, responsive to one or more virtual conditions, modifying a virtual trajectory of any visible dynamic virtual representation of any physical object.

7. The method of claim 2 further comprising limiting the detection of virtual collisions to the FOV's associated with a group of two or more of the physical regions.

8. The method of claim 1 further comprising a physical object capture mechanism configured to capture any physical object launched towards the shared display device.

9. The method of claim 1, wherein delineating the FOV and the corresponding vanishing point for each of the plurality of physical regions further comprises:
virtually segmenting the shared display device into a plurality of virtual viewports;
each virtual viewport associated with a corresponding one of the physical regions; and
each virtual viewport corresponding to a perspective correct visualization based on the vanishing point associated with the corresponding FOV;

10. The method of claim 1 further comprising, for one or more of the physical regions, determining an actual trajectory of a laser beam directed from the corresponding physical region towards the shared display device.

11. The method of claim 10 further comprising, within any FOV, detecting virtual collisions between any of the visible virtual target object or the invisible version of the virtual target object and any corresponding laser beam.

12. A system, comprising:
a hardware processor device;
a shared display device; and
a memory device storing machine-readable instructions which, when executed by the hardware processor device, cause the hardware processor device to:
render a virtual environment on the shared display device;
for each of a plurality of physical bays positioned relative to the shared display device, delineate a corresponding field of view (FOV) covering at least a portion of the shared display device and further delineate a corresponding vanishing point for each FOV;
for one of the bays, responsive to the corresponding FOV and vanishing point, render a visible virtual target object into the virtual environment;
for each of one or more of the other bays, responsive to the FOV and vanishing point of each of those other bays, position a separate instance of an invisible virtual object corresponding to the visible virtual target object into the virtual environment;
for each of one or more of the bays, determine an actual trajectory of a physical object launched from the corresponding bay towards the shared display device; and
responsive to the physical objects launched from one or more of the bays, render a corresponding visible virtual object into the virtual environment, each visible virtual object having a virtual trajectory determined from the corresponding actual trajectory, the FOV and the vanishing point of the corresponding bay.

13. The system of claim 12, wherein the machine-readable instructions, when executed by the hardware processor device, cause the hardware processor device to detect, responsive to the virtual trajectories of any of the visible virtual objects, positions of any of the visible virtual target objects and positions of the invisible virtual objects within the FOV of any of the bays, virtual collisions between of those visible virtual target objects, visible virtual objects and invisible virtual objects.

14. The system of claim 13, wherein the machine-readable instructions, when executed by the hardware processor device, cause the hardware processor device to modify the virtual trajectory of any of the visible virtual objects and any of the invisible virtual objects associated with a detected collision.

15. The system of claim 12, wherein the machine-readable instructions, when executed by the hardware processor device, cause the hardware processor device to modify the virtual trajectory of any of the visible virtual objects and any of the invisible virtual objects in response to one or more virtual conditions.

16. A system comprising:
a hardware processor device;
a shared display device; and
a memory device storing machine-readable instructions which, when executed by the hardware processor device, cause the hardware processor device to:
render a virtual environment on the shared display device;
for each of two or more separate physical locations positioned relative to the shared display device, determine a corresponding vanishing point of a field of view (FOV) of a virtual camera positioned within each of the physical locations;
for one or more of the physical locations, determine an actual trajectory of a physical object launched from the corresponding physical location towards the shared display device; and
responsive to each actual trajectory and further responsive to the FOV and vanishing point associated with the corresponding physical location, render a perspective correct visible virtual object representative of the physical object onto the virtual environment, each visible virtual object having a virtual trajectory determined from the corresponding actual trajectory, the FOV and the vanishing point of the corresponding physical location.

17. The system of claim 16, wherein the machine-readable instructions, when executed by the hardware processor device, cause the hardware processor device to:
render, for each of one or more of the physical locations, a separate corresponding instance of a visible virtual target object onto the virtual environment; and
each separate instance of the visible virtual target object having a perspective correct appearance responsive to the FOV and the vanishing point of the corresponding physical location.

18. The system of claim 17, wherein the machine-readable instructions, when executed by the hardware processor device, cause the hardware processor device to detect any virtual collisions between the visible virtual object and the corresponding instance of the visible virtual target object within the FOV of any of the physical locations.

19. The system of claim 16, wherein the machine-readable instructions, when executed by the hardware processor device, cause the hardware processor device to:
render, for one of the physical locations, a visible virtual target object onto the virtual environment responsive to the FOV and the vanishing point of that physical location; and
position, for one or more of the other physical locations, a separate instance of an invisible virtual object corresponding to the visible virtual target object onto the virtual environment responsive to the FOV and the vanishing point of each corresponding physical location.

20. The system of claim 19, wherein the machine-readable instructions, when executed by the hardware processor device, cause the hardware processor device to detect, within the FOV of any of the physical locations, any virtual collisions between the visible virtual object and either the corresponding instance of the visible virtual target object or the corresponding instance of the invisible virtual object.
